(19) United States
(12) Patent Application Publication
(10) Pub. No.: US 2024/0425388 A1
(43) Pub. Date: Dec. 26, 2024

(54) SYSTEM AND METHOD FOR OPTIMIZING OPERATIONS OF SEAWATER REVERSE OSMOSIS PROCESS

(71) Applicant: ACWA POWER Company, Riyadh (SA)

(72) Inventors: Hassan Abdulaziz ALMSAEED, Dubai (AE); Muhammad Ghifari RIDWAN, Dubai (AE); Ratul DAS, Thuwal (SA)

(73) Assignee: ACWA POWER Company, Riyadh (SA)

(21) Appl. No.: 18/745,841

(22) Filed: Jun. 17, 2024

Related U.S. Application Data
(60) Provisional application No. 63/509,682, filed on Jun. 22, 2023.

(51) Int. Cl. C02F 1/44; C02F 103/08; G06N 20/00

(52) U.S. Cl. CPC C02F 1/441; G06N 20/00; C02F 2103/08; C02F 2209/006

(57) ABSTRACT

A system and method for optimizing a seawater reverse osmosis process receives operational data associated with a desalination plant. The operational data includes a set of parameters associated with seawater used at that plant. That seawater is passed through a reverse osmosis membrane unit to output at least a first permeate stream and a second permeate stream. The system receives first permeate stream data and second permeate stream data, and retrieves reference data, including reference first and second permeate stream data. The system provides, as input to a Machine Learning (ML) model, the operational data, the first and second permeate stream data, and the reference data. The system determines a split ratio value based upon output of the ML model, and modifies parameters associated with the seawater based upon the split ratio value.

### CROSS-REFERENCE TO RELATED APPLICATIONS

This application claims priority to U.S. Provisional Patent Application Ser. No. 63/509,682, filed Jun. 22, 2023, and entitled “METHOD AND SYSTEM FOR OPTIMIZING SEAWATER DESALINATION OPERATION”, the disclosure of which is incorporated herein by reference.

### TECHNICAL FIELD

This disclosure relates to seawater reverse osmosis (SWRO) process. More specifically, the present disclosure relates to optimizing operations of the seawater reverse osmosis (SWRO) process using machine learning algorithm.

### BACKGROUND

In recent years, the global issue of shortage of freshwater has been increasing rapidly. The shortage of freshwater is a major problem owing to extreme weather conditions, desertification, and water pollution. As freshwater nourishes and sustains life, incessant population growth demands a greater supply of freshwater. To meet the increasing demand for freshwater, seawater reverse osmosis (SWRO) is being widely used technology to produce freshwater from seawater which is present abundantly on the earth. Specifically, the SWRO process reduces total dissolved solids (TDS), such as salts within the seawater to produce the freshwater. Such SWRO process takes place in a desalination plant that includes multiple components such as pumps, membranes, valves, energy recovery devices, and the like. Specifically, membrane technology is used in the desalination plant for seawater TDS reduction. Therefore, operations of the desalination plant for desalinating the seawater using the SWRO process can be complex, counterintuitive, as well as energy intensive. As energy conservation has become a priority around the world, it is imperative to minimize energy consumption for the SWRO process.

Furthermore, due to periodic changes in seawater quality and weather conditions, the operating parameters in the SWRO process need continuous monitoring to minimize energy consumption and to further optimize the use of the membrane technology such that water quality requirements are met. Therefore, there is a requirement for an optimizing the operations of the SWRO process (or desalination plants).

### SUMMARY

A system and method for optimizing operations of seawater reverse osmosis process is provided.

In one aspect, a system for optimizing operations of seawater reverse osmosis process is described. The system may include a memory configured to store a computer-executable instructions and one or more processors coupled to the memory. The processor may be configured to receive operational data associated with a desalination plant. The operational data includes a set of parameters associated with seawater. Further, the seawater is passed through a reverse osmosis (RO) membrane unit to output at least a first permeate stream and a second permeate stream. The processor may be further configured to receive first permeate stream data including a first flowrate value of the first permeate stream, and a first conductivity value of the first permeate stream. The processor may be further configured to receive second permeate stream data including a second flowrate value of the second permeate stream, and a second conductivity value of the second permeate stream. The processor may be further configured to retrieve reference data associated with the desalination plant. The reference data includes reference first permeate stream data, and reference second permeate stream data. Further, the processor may be configured to provide, as an input, the operational data, the first permeate stream data, the second permeate stream data, and the reference data to a Machine Learning (ML) model. The processor may be configured to determine a split ratio value associated with the first permeate stream and the second permeate stream based on an output of the ML model and modify at least a first parameter of the set of parameters associated with the seawater based on the determined split ratio value.

In additional system embodiments, the output of the ML model may be correction factor data. The correction factor data corresponds to a first deviation in one or more values associated with the first permeate stream data from corresponding one or more values associated with the reference first permeate stream data, and a second deviation in one or more values associated with the second permeate stream data from corresponding one or more values associated with the reference second permeate stream data.

In additional system embodiments, the processor may be configured to retrieve one or more limiting criteria associated with the desalination plant. The processor may be further configured to evaluate one or more values associated with the correction factor data based on the one or more limiting criteria to determine the split ratio value.

In additional system embodiments, the one or more limiting criteria includes at least a first criterion associated with one or more quality parameters associated with the first permeate stream, and a second criterion associated with a quantity of the second permeate stream passed through the RO membrane unit to output at least a third permeate stream.

In additional system embodiments, the desalination plant produces a filtered liquid stream from the seawater. The filtered liquid stream includes the first permeate stream, and the third permeate stream.

In additional system embodiments, the ML model is trained on a training dataset including historical operational data associated with the desalination plant, historical first permeate stream data, and historical second permeate stream data. The processor may be further configured to train the ML model based on the historical operational data, the historical first permeate stream data, and the historical second permeate stream data.

In additional system embodiments, the first parameter of the set of parameters associated with the seawater corresponds to a flowrate value of the seawater.

In additional system embodiments, the set of parameters associated with the seawater includes at least one of a flowrate of the seawater, a temperature value of the seawater, a conductivity value of the seawater, chemical composition data associated with the seawater, a density of the seawater, a Potential of Hydrogen (pH) value of the seawater, and a total dissolved solids (TDS) value of the seawater.

In additional system embodiments, the operational data associated with the desalination plant further includes at least one of data associated with the RO membrane unit, one or more quality parameters of a filtered liquid stream, a total dissolved solids (TDS) value of the filtered liquid stream, a recovery rate of the desalination plant, and split ratio data.

In additional system embodiments, the reference first permeate stream data includes an optimal flowrate value of the first permeate stream, and an optimal conductivity value of the first permeate stream. The reference second permeate stream data includes an optimal flowrate value of the second permeate stream, and an optimal conductivity value of the second permeate stream.

In additional system embodiments, the reference data further includes an optimal flowrate value of the seawater, an optimal conductivity value of the seawater, one or more optimal quality parameters associated with a filtered liquid stream, and optimal split ratio data.

In another aspect, a method for optimizing operations of seawater reverse osmosis process is described. The method may include receiving operational data associated with a desalination plant. The operational data includes a set of parameters associated with seawater. Further, the seawater is passed through a reverse osmosis (RO) membrane unit to output at least a first permeate stream and a second permeate stream. The method may include receiving first permeate stream data including a first flowrate value of the first permeate stream, and a first conductivity value of the first permeate stream. The method may include receiving second permeate stream data including a second flowrate value of the second permeate stream, and a second conductivity value of the second permeate stream. The method may include retrieving reference data associated with the desalination plant. The reference data includes reference first permeate stream data, and reference second permeate stream data. Further, the method may include providing, as an input, the operational data, the first permeate stream data, the second permeate stream data, and the reference data to a Machine Learning (ML) model. The method may include determining a split ratio value associated with the first permeate stream and the second permeate stream based on an output of the ML model and modifying at least a first parameter of the set of parameters associated with the seawater based on the determined split ratio value.

In additional method embodiments, the output of the ML model may be correction factor data. The correction factor data corresponds to a first deviation in one or more values associated with the first permeate stream data from corresponding one or more values associated with the reference first permeate stream data, and a second deviation in one or more values associated with the second permeate stream data from the corresponding one or more values associated with the reference second permeate stream data.

In additional method embodiments, the method may include retrieving one or more limiting criteria associated with the desalination plant. The method may include evaluating one or more values associated with the correction factor data based on the one or more limiting criteria to determine the split ratio value.

In additional method embodiments, the one or more limiting criteria includes at least a first criterion associated with one or more quality parameters associated with the first permeate stream, and a second criterion associated with a quantity of the second permeate stream passed through the RO membrane unit to output at least a third permeate stream.

In additional method embodiments, the ML model is trained on a training dataset including historical operational data associated with the desalination plant, historical first permeate stream data, and historical second permeate stream data. The method may include training the ML model based on the historical operational data, the historical first permeate stream data, and the historical second permeate stream data.

In additional method embodiments, the first parameter of the set of parameters associated with the seawater corresponds to a flowrate value of the seawater.

In additional method embodiments, the set of parameters associated with the seawater includes at least one of a flowrate value of the seawater, a temperature value of the seawater, a conductivity value of the seawater, chemical composition data associated with the seawater, a density of the seawater, a Potential of Hydrogen (pH) value of the seawater, and a total dissolved solid (TDS) value of the seawater.

In additional method embodiments, the operational data associated with the desalination plant further includes at least one of data associated with the RO membrane unit, one or more quality parameters of a filtered liquid stream, a total dissolved solid (TDS) value of the filtered liquid stream, a recovery rate of the desalination plant, and split ratio data.

In yet another aspect, a non-transitory computer-readable storage medium carrying one or more sequences of one or more instructions which, when executed by at least one processor, cause a system to perform operations including, receiving operational data associated with a desalination plant. The operational data includes a set of parameters associated with seawater. Further, the seawater is passed through a reverse osmosis (RO) membrane unit to output at least a first permeate stream and a second permeate stream. The operations may include receiving first permeate stream data including a first flowrate value of the first permeate stream, and a first conductivity value of the first permeate stream. The operations may include receiving second permeate stream data including a second flowrate value of the second permeate stream, and a second conductivity value of the second permeate stream. The operations may include retrieving reference data associated with the desalination plant. The reference data includes reference first permeate stream data, and reference second permeate stream data. Further, the operations may include providing, as an input, the operational data, the first permeate stream data, the second permeate stream data, and the reference data to a Machine Learning (ML) model. The operations may include determining a split ratio value associated with the first permeate stream and the second permeate stream based on an output of the ML model and modify at least a first parameter of the set of parameters associated with the seawater based on the determined split ratio value.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a diagram that illustrates a network environment in which a system for optimizing operations of seawater reverse osmosis process is implemented, in accordance with an embodiment of the disclosure;

FIG. 2 illustrates a block diagram of the system of FIG. 1, in accordance with an embodiment of the disclosure;

FIG. 3 is a diagram that illustrates exemplary operations for optimizing operations of seawater reverse osmosis process, in accordance with an embodiment of the disclosure;

FIG. 4 is a diagram that illustrates exemplary operations for optimizing operations of seawater reverse osmosis process using machine learning model, in accordance with an embodiment of the disclosure; and

FIG. 5 is a flowchart that illustrates an exemplary method for optimizing operations of seawater reverse osmosis process, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

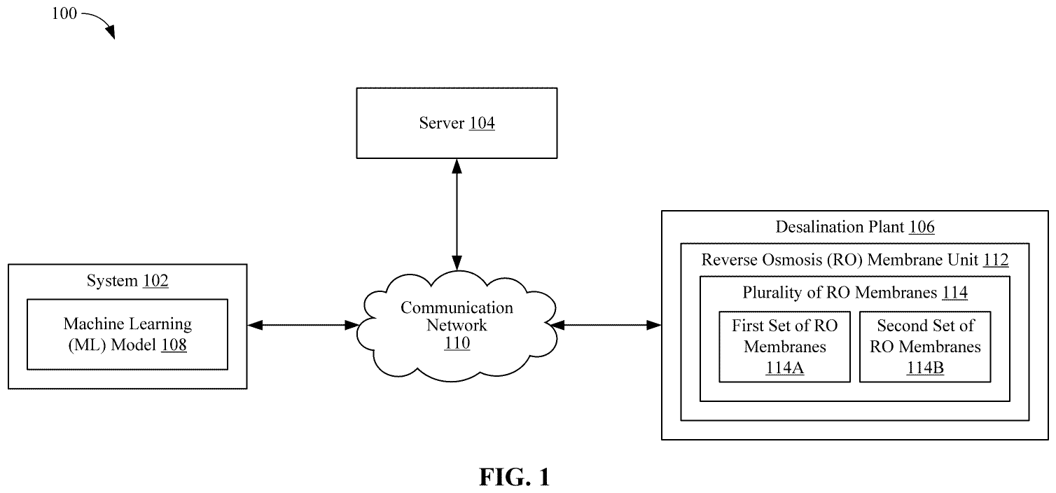

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 5, a brief description concerning the various components of the present disclosure will now be briefly discussed. Reference will be made to the figures showing various embodiments of a method and a system for optimizing seawater reverse osmosis process.

FIG. 1 is a diagram that illustrates a network environment in which a system for optimizing operations of seawater reverse osmosis process is implemented, in accordance with an embodiment of the disclosure. With reference to FIG. 1, there is shown a network environment 100. The network environment 100 may include a system 102, a server 104, a desalination plant 106, a machine learning (ML) model 108, and a communication network 110. Further, the desalination plant 106 may employ a seawater reverse osmosis (SWRO) process to produce a filtered liquid stream from seawater.

The system 102 may correspond to a machine learning-based system that may have the capability of optimizing operations of the desalination plant 106, thereby improving the efficiency and cost-effectiveness of the SWRO process. Further, the system 102 may enhance the design of the desalination plant 106 to minimize energy consumption and standardize the quality of the purified water. In an example, the system 102 may correspond to a simulation system for simulating the operation of an entire SWRO plant. For example, the system 102 may correspond to a computer executable algorithm to achieve one or more functions of the machine learning-based system for optimizing the SWRO process.

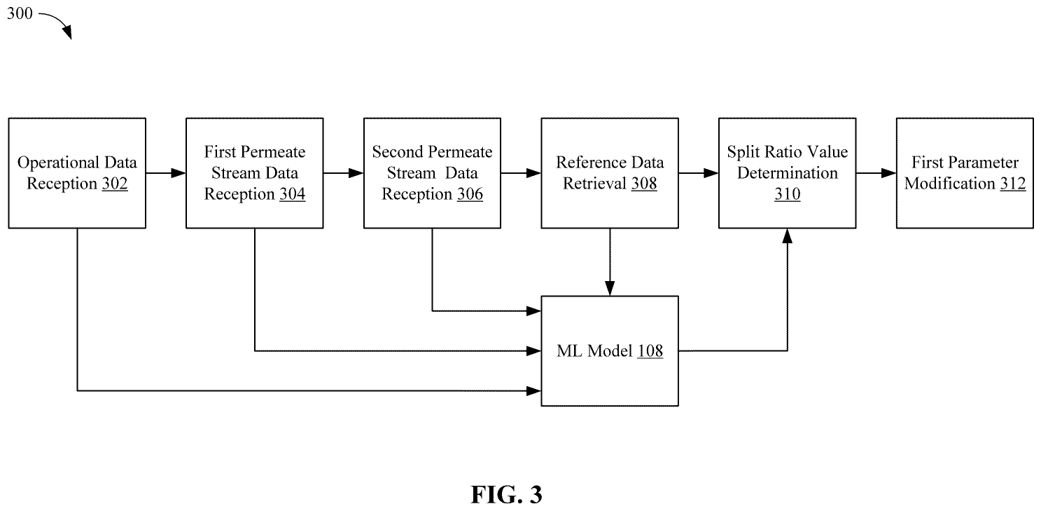

In an embodiment, the system 102 may receive operational data associated with the desalination plant 106. The operational data may include a set of parameters associated with seawater. The seawater may be passed through a reverse osmosis (RO) membrane unit 112 to output a first permeate stream and a second permeate stream. Further, the system 102 may be configured to receive first permeate stream data including a first flowrate value of the first permeate stream and a first conductivity value of the first permeate stream. The system 102 may be further configured to receive second permeate stream data including a second flowrate value of the second permeate stream and a second conductivity value of the second permeate stream. Additionally, the system 102 may retrieve reference data associated with the desalination plant 106 including reference first permeate stream data, and reference second permeate stream data. Details of the operational data, first permeate stream data, second permeate stream data, and the reference data are provided for example, in FIG. 3.

The system 102 may further include the ML model 108. The system 102 may be further configured to provide, as an input, the operational data, the first permeate stream data, the second permeate stream data, and the reference data to the ML model 108. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before or while training the neural network on a training dataset. Each node of the neural network may correspond to a mathematical function (e.g., a sigmoid function or a rectified linear unit) with a set of parameters, tunable during training of the neural network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function.

In the training of the neural network, one or more parameters of each node of the neural network may be updated based on whether an output of the final layer for a given input (from a training dataset) matches a correct result based on a loss function for the neural network. The above process may be repeated for the same or a different input until a minimum loss function may be achieved, and a training error may be minimized. Several methods for training are known in the art, for example, gradient descent, stochastic gradient descent, batch gradient descent, gradient boost, meta-heuristics, and the like.

The ML model 108 may include electronic data, such as, for example, a software program, code of the software program, libraries, applications, scripts, or other logic or instructions for execution by a processing device, such as circuitry. The ML model 108 may be implemented using hardware including a processor, a microprocessor (e.g., to perform or control the performance of one or more operations), a field-programmable gate array (FPGA), or an application-specific integrated circuit (ASIC). Alternatively, in some embodiments, the ML model 108 may be implemented using a combination of hardware and software. Although in FIG. 1, the ML model 108 is shown integrated within the system 102, the disclosure is not so limited. Accordingly, in some embodiments, the ML model 108 may be a separate entity in the system 102, without deviation from the scope of the disclosure. Examples of the ML model 108 may include, but are not limited to, a regression based model, a deep neural network (DNN) based model, a convolutional neural network (CNN) based model, a CNN-recurrent neural network (CNN-RNN) based model, R-CNN, Fast R-CNN based model, Faster R-CNN based model, an artificial neural network (ANN) based model, a fully connected neural network based model, and/or a combination of such networks.

The network environment 100 may further include the server 104. The server 104 may be a specialized machine that may be designed for a specific task within the network environment 100. The server 104 may play a crucial role in responding to the system 102 request, processing data, and delivering the data efficiently. The server 104 may be designed for high-performance computing and data handling, ensuring that the system 102 requests may be handled accordingly and that the requested content is delivered to the system 102 seamlessly. For example, the server 104 may include but is not limited to, a mail server, a data server, an application server, or a database server.

A person with ordinary skill in the art will understand that the scope of the disclosure may not be limited to the implementation of the server 104 and the system 102 as two separate entities. In certain embodiments, the functionalities of the server 104 can be incorporated in its entirety or at least partially in the system 102, without a departure from the scope of the disclosure.

In an embodiment, the system 102 may be communicatively coupled to the desalination plant 106, the server 104 or any other device, via a communication network 110. The communication network 110 may be wired, wireless, or any combination of wired and wireless communication networks, such as cellular, Wi-Fi, internet, local area networks, or the like. In some embodiments, the communication network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for example LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

All the components in the network environment 100 may be coupled directly or indirectly to the communication network 110. The components described in the network environment 100 may be further broken down into more than one component and/or combined in any suitable arrangement. Further, one or more components may be rearranged, changed, added, and/or removed.

In operation, the system 102 may be communicatively coupled to the desalination plant 106 via the communication network 110. The desalination plant 106 may correspond to a facility that may be designed to perform SWRO process to produce the filtered liquid stream from the seawater that may be provided as input to the desalination plant 106. The SWRO process may employ the use of semi-permeable membranes that allow a solvent to pass through, while restricting solutes (such as impurities), leading to the separation of salt and freshwater. The desalination plant 106 may be configured to receive the seawater or saltwater. For example, the seawater may have a high salt content, thereby making the seawater unsafe for consumption by humans.

Conventionally, a seawater desalination technique may be employed to obtain the filtered liquid stream by removing excessive salt content from the seawater. The filtered liquid stream may correspond to, but is not limited to, freshwater. The potential of Hydrogen (pH) value of the filtered liquid stream may lie within the range of 5 to 7.2, making the filtered liquid stream safe for human consumption, irrigation, and other industrial purposes. Examples of various methods of treatment of the seawater desalination may include, but are not limited to, an evaporation of the seawater, and a membrane separation method based on differential and selective permeation ability of the membrane. In an example, the membrane separation method may correspond to a reverse osmosis (RO) process. The RO process may refer to a technique by which the freshwater (or the filtered liquid stream) may be extracted from the seawater by application of a pressure higher than osmotic pressure of the seawater with a semi-permeable membrane interposed in between.

In an embodiment, the desalination plant 106 may employ SWRO process to remove excessive salt content from the seawater. The SWRO process may involve multiple stages or passes. For example, the seawater may go through partial treatment during each pass through the reverse osmosis (RO) membrane unit 112, thereby allowing effective removal of impurities and improving the quality of the filtered liquid stream. In an embodiment, the RO membrane unit 112 may correspond to a pressure vessel including a plurality of RO membranes 114. In one instance, the desalination plant 106 may include one or more reverse osmosis (RO) membrane units (such as one or more pressure vessels) such that a first set of RO membranes 114A from the plurality of RO membranes 114 may form a first pass and a second set of RO membranes 114B from the plurality of RO membranes 114 may form a second pass in the desalination plant 106. In an example, the plurality of RO membranes 114 in the RO membrane unit may correspond to seven RO membranes, but this should not be construed as a limitation. In another example, plurality of RO membranes 114 in the RO membrane unit may correspond to, such as but is not limited to, two, three, four, eight, and ten.

For example, the first set of RO membranes 114A of the first pass and the second set of RO membranes 114B of the second pass may collectively form the RO membrane unit 112. In an example, the first set of RO membranes 114A may be same as the second set of RO membranes 114B. In another example, the first set of RO membranes 114A may be different from the second set of RO membranes 114B. In an example, a number of the first set of RO membranes 114A may be equal to a number of the second set of RO membranes 114B in the RO membrane unit 112. In another example, a number of the first set of RO membranes 114A may be less than a number of the second set of RO membranes 114B in the RO membrane unit 112. In yet another example, the number of the first set of RO membranes 114A may be more than the number of the second set of RO membranes 114B in the RO membrane unit 112.

During the SWRO process, the seawater (or seawater or salt water) may be passed through the RO membrane unit 112. For example, the RO membrane unit 112 may separate the seawater into brine stream (or concentrated water) and a permeate stream. The permeate stream may further include a front permeate stream (or the first permeate stream) and a rear permeate stream (or the second permeate stream). Specifically, the permeate stream may split into the first permeate stream and the second permeate stream. In an example, the seawater may be passed through the first set of RO membranes 114A in the RO membrane unit 112 to output the front permeate stream (or the first permeate stream), and the seawater may be further passed through the second set of RO membranes 114B in the RO membrane unit 112 to output the rear permeate stream (or the second permeate stream).

It may be noted that the first permeate stream may have a higher water quality than the second permeate stream. In general, the seawater concentration for each RO membrane of the plurality of RO membranes 114 keeps increasing as it goes towards a last RO membrane of the plurality of RO membranes 114 from a first membrane of the plurality of RO membranes 114 in the RO membrane unit 112. For example, the seawater concentration corresponds to a salt concentration in the seawater or salinity of the seawater. Therefore, when a feed pressure of the seawater remains same throughout the RO membrane unit 112, the last RO membrane of the plurality of RO membranes 114 may have a lower recovery rate, a lower salt rejection rate, and a lower water quality as compared to a preceding RO membrane of the plurality of RO membranes 114. Further, in the RO membrane unit 112, a permeate stream from a preceding RO membrane of the plurality of RO membranes 114 will blend with a permeate stream from a subsequent RO membrane of the plurality of RO membranes 114, thereby resulting in gradual decrease of permeate water quality across the RO membrane unit 112. As a result, the first permeate stream obtained from the first set of RO membraned 114A may have a higher water quality than the second permeate stream obtained from the second set of RO membraned 114B.

Subsequently, the second permeate stream from the second pass may be transferred to the RO membrane unit 112 to produce the output permeate stream (also referred to as third permeate stream, hereinafter). In other words, the second permeate stream may be passed through a third set of RO membranes of the plurality of RO membranes 114 in the RO membrane unit 112 to output at least the third permeate stream. Such a process may correspond to a second step of filtration of the desalination plant 106. In an example, the third set of RO membranes may be same as the first set of RO membranes 114A or the second set of RO membranes 114B of the plurality of RO membranes 114. In an example, the third set of RO membranes may be different from the first set of RO membranes 114A or the second set of RO membranes 114B of the plurality of RO membranes 114.

In this regard, the first permeate stream of the first pass, and the third permeate stream from the second step of filtration may have to be blended or mixed to produce a desired quality filtered liquid stream as an output of the SWRO process in the desalination plant 106. However, such design of the desalination plant 106 is only exemplary and should not be construed as a limitation. In an example, such SWRO process involving passing of the second permeate stream through the RO membrane unit 112, and thereafter mixing or blending of the first permeate stream and the third permeate stream may be complex and energy intensive. As energy conservation has become a priority around the world, it is imperative to minimize energy consumption for the SWRO process. This calls for the need for optimizing the SWRO process of desalination plant 106 regarding design and operation.

To overcome the drawbacks associated with the desalination plant 106, the disclosed system 102 may optimize the operation of the desalination plant 106 by determining an optimum amount of the first permeate stream, such that a minimal amount of the second permeate stream may be produced that may require the second step of filtration. For example, the system 102 may be configured to determine a split ratio value. The split ratio value may refer to as a ratio between an amount of the first permeate stream and an amount of the second permeate stream produced. In an example, the amount of the first permeate stream may correspond to a quantity of the first permeate stream that may not require the second step of filtration and needs to be transferred as output of the desalination plant 106. Further, an amount of the second permeate stream may correspond to a quantity of the second permeate stream that may require the second step of filtration in the desalination plant 106.

In an embodiment, the system 102 may be configured to provide, as an input, the operational data, the first permeate stream data, the second permeate stream data, and the reference data to the ML model 108. Thereafter, the system 102 may be configured to determine a split ratio value associated with the first permeate stream and the second permeate stream based on an output of the ML model 108. Further, the system 102 may be configured to modify at least a first parameter of the set of parameters associated with the seawater based on the determined split ratio value. In such a scenario, the system 102 may employ the adjustment of the first parameter of the set of parameters associated with the seawater to achieve an optimal split ratio value. The optimal split ratio value may refer to as an ideal ratio between an optimal amount of the first permeate stream and an optimal amount of the second permeate stream produced. In an example, an optimal amount of the first permeate stream may correspond to a quantity of the first permeate stream that may not require the second step of filtration and needs to be transferred as output of the desalination plant 106. Further, an optimal amount of the second permeate stream may correspond to a quantity of the second permeate stream that may require the second step of filtration in the desalination plant 106.

The disclosed system 102 may optimize the operation of the desalination plant 106 by achieving the optimal split ratio value, thereby minimizing the amount of the second permeate stream that needs to be passed through the second step of filtration of the desalination plant 106. Further, the system 102 may be configured to control the blend of the first permeate stream and the third permeate stream based on the optimal split ratio value, thereby allowing to minimize energy consumption and/or chemicals required to desalinate the seawater. This may further allow optimization of the operations of the desalination plant 106.

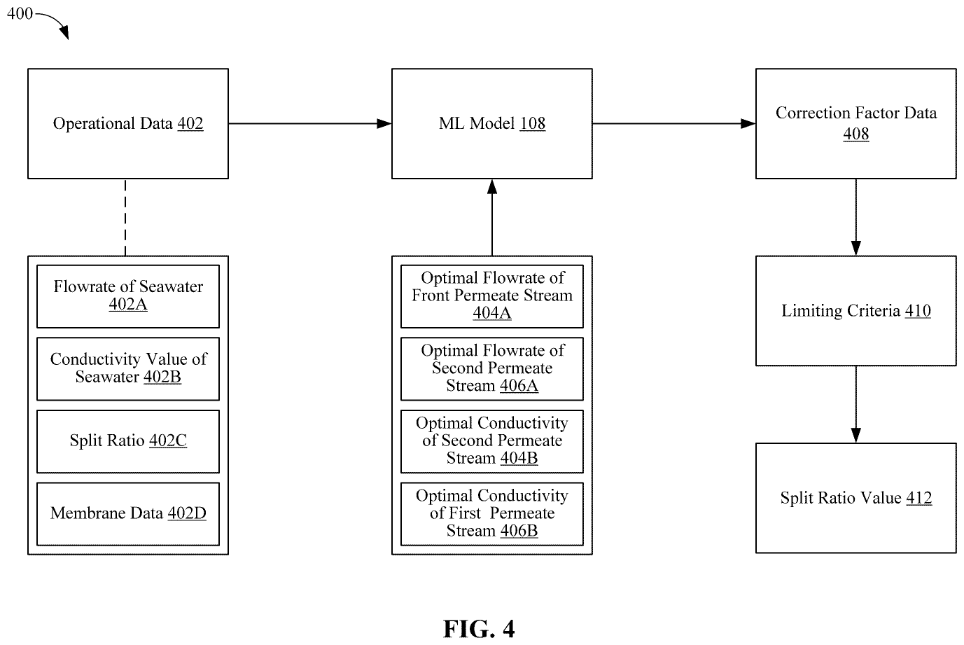

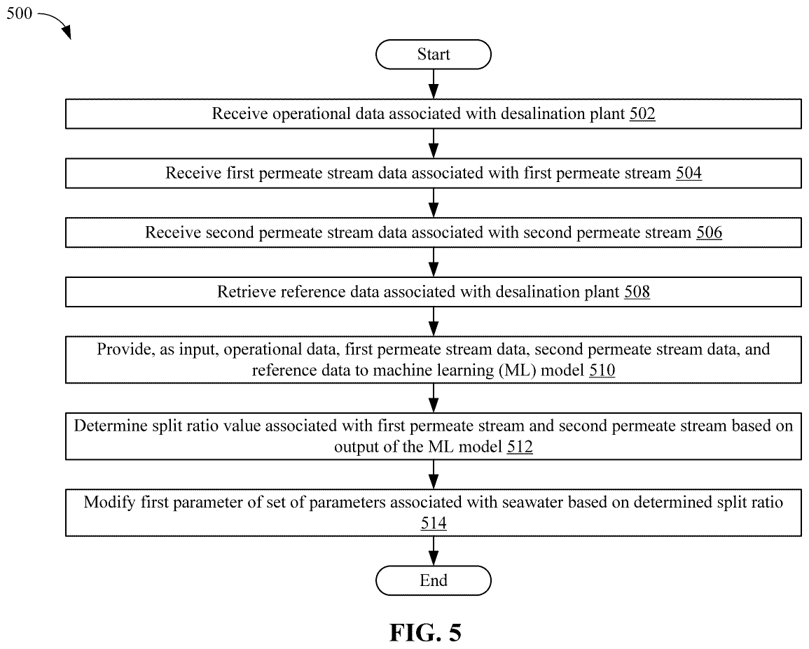

The functions or operations executed by the system 102 are described in detail, for example, in FIG. 3, FIG. 4, and FIG. 5.

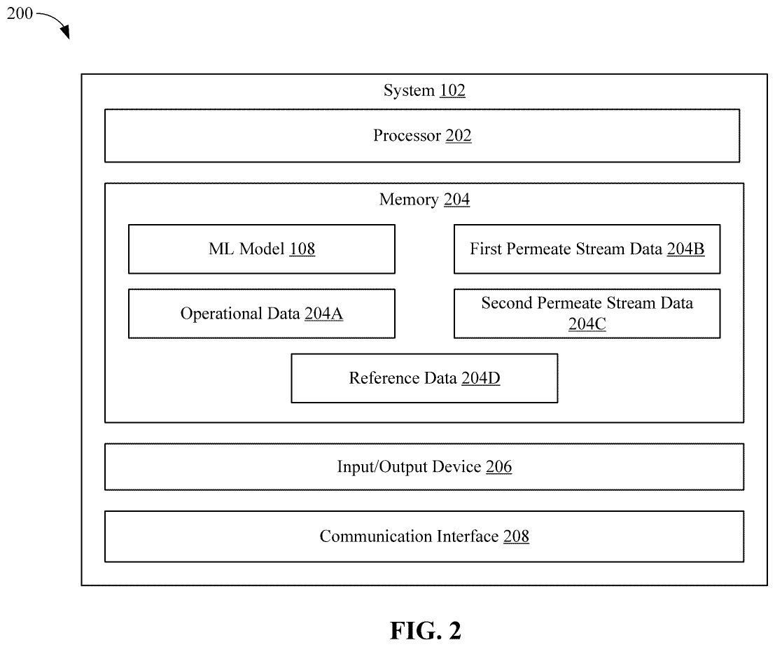

FIG. 2 illustrates a block diagram of the system of FIG. 1, in accordance with an embodiment of the disclosure. FIG. 2 is explained in conjunction with FIG. 1. In FIG. 2, there is shown the block diagram 200 of the system 102. The system 102 may include at least one processor (referred to as a processor 202, hereinafter), at least one non-transitory memory (referred to as a memory 204, hereinafter), an input/output (I/O) device 206, and a communication interface 208. The processor 202 may be connected to the memory 204, the I/O device 206, and the communication interface 208 through one or more wired or wireless connections. The memory 204 may further include the ML model 108, operational data 204A, first permeate stream data 204B, second permeate stream data 204C, and reference data 204D. Although in FIG. 2, it is shown that the system 102 includes the processor 202, the memory 204, the I/O device 206, and the communication interface 208 however, the disclosure may not be so limiting and the system 102 may include fewer or more components to perform the same or other functions of the system 102.

The processor 202 of the system 102 may be configured to perform one or more operations associated with optimization of the operations of the SWRO process in desalination plants. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an embodiment, the processor 202 may be configured to train the ML model 108 on a training dataset and store the ML model 108 in the memory 204. The ML model 108 may be a type of neural network model.

In an example embodiment, the processor 202 may be in communication with the memory 204 via a bus for passing information among components of the system 102. For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication network may be accessed using the communication interface 208 of the system 102. The communication interface 208 may provide an interface for accessing various features and data stored in the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In an embodiment, the processor 202 may further receive the operational data 204A associated with the desalination plant 106 and store the operational data 204A in the memory 204. The operational data 204A includes a set of parameters associated with the seawater. In another embodiment, the memory 204 may be configured to store the first permeate stream data 204B including a first flowrate value of the first permeate stream, and a first conductivity value of the first permeate stream. In yet another embodiment, the memory 204 may be configured to store the second permeate stream data 204C including a second flowrate value of the second permeate stream, and a second conductivity value of the second permeate stream. In an example, the memory 204 may be configured to store historical operational data, historical first permeate stream data, and historical second permeate stream data. Further, the memory 204 may store historical data from the desalination plant 106 for at least 3 years or more.

In some example embodiments, the I/O device 206 may communicate with the system 102 and display the input and/or output of the system 102. As such, the I/O device 206 may include a display and, in some embodiments, may also include a keyboard, a mouse, a touch screen, touch areas, soft keys, or other input/output mechanisms. In one embodiment, the system 102 may include a user interface circuitry configured to control at least some functions of one or more I/O device elements such as a display and, in some embodiments, a plurality of speakers, a ringer, one or more microphones and/or the like.

The communication interface 208 may include the input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communication device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

FIG. 3 is a diagram that illustrates exemplary operations for optimizing operations of seawater reverse osmosis process, in accordance with an embodiment of the disclosure. FIG. 3 is explained in conjunction with FIG. 1 and FIG. 2. With reference to FIG. 3, there is shown the block diagram 300 that illustrates exemplary operations from 302 to 312, as described herein. The exemplary operations illustrated in the block diagram 300 may start at 302 and may be performed by any computing system, apparatus, or device, such as the system 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the implementation.

At 302, operational data may be received. In an embodiment, the processor 202 may be configured to receive the operational data 204A associated with the desalination plant 106 that produces a filtered liquid stream from seawater. The operational data 204A may correspond to operating data of the desalination plant 106, while the desalination plant 106 is in operation. The operational data 204A may further include a set of parameters associated with the seawater. The set of parameters associated with the seawater include, for example, but are not limited to, a flowrate value of the seawater, a temperature value of the seawater, a conductivity value of the seawater, chemical composition data associated with the seawater, a density of the seawater, a Potential of Hydrogen (pH) value of the seawater, and a total dissolved solids (TDS) value of the seawater. The flowrate value of the seawater may correspond to the volume of the seawater passing through a given point in a particular amount of time. The temperature value of the seawater may indicate a thermal condition (for example, a degree of heat or coldness) associated with the seawater. The conductivity value of the seawater may be a measure of the ability of the seawater to pass electrical current. The conductivity value of the seawater may be determined by a potable water quality checker device that may be integrated with the system 102. The chemical composition data associated with the seawater may correspond to the concentration of each of a set of chemical compounds in the seawater. The set of chemical compounds may include, for example, but are not limited to, sulphate, magnesium, calcium, and potassium. The density of the seawater may correspond to the measure of mass per unit volume of the seawater. The density may be influenced by various factors such as, but not limited to, salinity, temperature, and pressure of the seawater. Further, the pH value of the seawater may correspond to a measure of the acidity and alkalinity of the seawater. The pH value of the seawater may range from, for example, but is not limited to, 7.5-8.4. For example, the pH of the seawater may depend on various factors such as, but are not limited to, location from which the seawater may be obtained, an amount of carbon dioxide dissolved in the seawater, temperature of the seawater, and biological activity of marine plants and algae present in the seawater. The TDS value of the seawater may be the total amount of solids that may be dissolved in the seawater, including soluble hydrogen carbonate ions, chloride salts, sulphates, calcium, magnesium, sodium, potassium, volatile solids, and non-volatile solids.

The operational data 204A may further include reverse osmosis (RO) membrane properties, and other operational parameters associated with the desalination plant 106, in addition to the set of parameters associated with the seawater. Specifically, the operational data 204A associated with the desalination plant 106 may further include, but is not limited to, data associated with the RO membrane unit 112, one or more quality parameters of the filtered liquid stream, a total dissolved solids (TDS) value of the filtered liquid stream, a recovery rate of the desalination plant, and split ratio data.

The data associated with the RO membrane unit 112 may correspond to RO membrane performance data. The data associated with the RO membrane unit 112 may further include information associated with membrane projections for the plurality of RO membranes 114 (such as the first set of RO membranes 114A of the first pass and/or the second set of RO membranes 114B of the second pass). The membrane projections may indicate multiple ranges of operating conditions of the RO membranes in the desalination plant 106. For example, the membrane projections may include information related to, membrane performance of the plurality of RO membranes 114 of the RO membrane unit 112 at different seawater temperature, membrane age configuration, and an amount of time that the RO membranes have been in operation. The membrane performance of the plurality of RO membranes 114 may correspond to the ability of the RO membrane to effectively remove contaminants such as salts, minerals, and impurities from the seawater at different temperatures of the seawater. The membrane age configuration may correspond to the age of the RO membrane. This may further include information associated with accumulation of fouling, scaling or degradation of the RO membrane material.

In an example, the one or more quality parameters of the filtered liquid stream may include, but are not limited to, physical parameters, chemical parameters, and biological parameters. The physical parameters may include, but are not limited to, colour, taste, odour, temperature, turbidity, solids, and electrical conductivity. The chemical parameters may include, include, but are not limited to pH, acidity, alkalinity, chlorine, hardness, dissolved oxygen, and biological oxygen. The biological parameters, may include, but are not limited to bacteria, algae, and viruses.

The total dissolved solids (TDS) value of the filtered liquid stream may be the total amount of solids that may be dissolved in the filtered liquid stream. The recovery rate of the desalination plant 106 may correspond to percentage of freshwater (or the filtered liquid stream) produced from the total seawater intake from the source. This may indicate efficiency of the desalination plant 106. The split ratio data may correspond to information associated with the split ratio value of the first permeate stream and the second permeate stream over the time. The split ratio value may refer to as a ratio between the amount of the first permeate stream and an amount of the second permeate stream produced, while the desalination plant 106 is in operation.

At 304, first permeate stream data may be received. In an embodiment, the processor 202 may be configured to receive the first permeate stream data 204B associated with the first permeate stream. The first permeate stream data 204B may correspond to data associated with parameters of the first permeate stream, while the desalination plant is in operation. The first permeate stream data 204B may include, but is not limited to, a first flowrate value of the first permeate stream, and a first conductivity value of the first permeate stream. The first flowrate value of the first permeate stream may correspond to the volume of the first permeate stream passing through the first set of RO membranes 114A in a particular amount of time. The first conductivity value of the first permeate stream may be a measure of the ability of the first permeate stream to pass electrical current.

At 306, second permeate stream data may be received. In an embodiment, the processor 202 may be configured to receive the second permeate stream data 204C associated with the second permeate stream. The second permeate stream data 204C may correspond to data associated with parameters of the second permeate stream, while the desalination plant 106 is in operation. The second permeate stream data 204C may include, but is not limited to, a second flowrate value of the second permeate stream, and a second conductivity value of the second permeate stream. The second flowrate value of the second permeate stream may correspond to the volume of the second permeate stream passing through the second set of RO membranes 114B in a particular amount of time. The second conductivity value of the second permeate stream may be a measure of the ability of the second permeate stream to pass electrical current.

At 308, reference data may be retrieved. In an embodiment, the processor 202 may be configured to retrieve the reference data 204D associated with the desalination plant 106. For example, the system 102 may be communicably coupled to an OEM (Original Equipment Manufacturer) cloud server. In an embodiment, the reference data 204D may be obtained from original equipment manufacturer (OEM) of the plurality of the RO membranes 114. Moreover, the reference data 204D may be obtained based on the membrane performance data associated with the RO membrane unit 112 received from the manufacturer of the plurality of RO membranes 114. In an example, the reference data 204D may be obtained using simulation model or software tools that may be developed or approved by the OEM. In an example, the reference data 204D may be generated based on expected membrane performance that may be provided by the supplier of plurality of RO membranes 114. Further, the reference data 204D may further include an optimal split ratio value associated with the first permeate stream and the second permeate stream.

The reference data 204D may include for example, but is not limited to, an optimal flowrate value of the seawater, an optimal conductivity value of the seawater, an optimal pressure value for the seawater, an optimal flowrate value of the first permeate stream, an optimal conductivity value of the first permeate stream, an optimal pressure value for the first permeate stream, an optimal flowrate value of the second permeate stream, an optimal conductivity value of the second permeate stream, an optimal pressure value for the second permeate stream, a recovery of the first pass, and a recovery of the second pass.

In an embodiment, the reference data 204D may further include, but is not limited to, reference first permeate stream data, and reference second permeate stream data. The reference first permeate stream data may include, but is not limited to, an optimal flowrate value of the first permeate stream, and an optimal conductivity value of the first permeate stream. The reference second permeate stream data may include, but is not limited to, an optimal flowrate value of the second permeate stream, and an optimal conductivity value of the second permeate stream.

Typically, the reference data 204D may be provided by suppliers or manufacturers of the plurality of RO membranes 114. However, relying on received information to control design and operations of the desalination plant 106 may be problematic. For example, the received reference data 204D from the suppliers may not match the actual performance of the plurality of RO membranes 114 in the desalination plant 106. In an example, such a deviation in the reference data 204D and actual performance (the operational data 204A) may arise due to having internal and external original equipment manufacturer (OEM) models or modes for generating such data. In another example, a deviation in the reference data 204D and actual performance (the operational data 204A) may arise due to errors in equations utilized in the OEM models for calculation of relevant parameters. Further, the reference data 204D supplied by the suppliers may not provide the desired quality or performance of the RO membranes. To this end, the reference data 204D in suppliers OEM models may result in discrepancies between theoretical values and actual values of the SWRO process in the desalination plant 106. These operating values may differ from internal safety margins that suppliers consider when generating the performance information. Therefore, due to several variables, such as the set of parameters associated with the seawater, data associated with the RO membrane unit 112, malfunction of the desalination plant, etc. involved in actual SWRO process for producing the freshwater, relying merely on the suppliers' performance information may not result in good or desired quality of freshwater or filtered liquid stream.

To this end, the OEM models considered by the suppliers for prediction of the membrane performance data and/or the operating data for the desalination plant 106 may lack accuracy. Therefore, the membrane performance data and the reference data based on the OEM model may not match actual RO membrane performance and reference data of the desalination plant 106 under real conditions. As a result, the received membrane performance data and the received reference data may be considered unreliable. For example, using the received membrane performance data and the received reference data provided by the suppliers based on the OEM model may lead to not reaching a target or desired blend permeate water quality or freshwater quality. This is undesirable and may impact overall operation, performance, and output of the desalination plant 106.

The embodiment of the present disclosure helps to overcome the aforementioned drawbacks associated with use of the received performance information and the reference data 204D from the OEM supplier by leveraging use of ML model 108 to determine the split ratio value associated with the first permeate stream and the second permeate stream.

At 310, split ratio value may be determined. In an embodiment, the processor 202 may be configured to determine the split ratio value associated with the first permeate stream and the second permeate stream based on an output of the ML model 108. In an embodiment, the processor 202 may be configured to provide, as an input, the operational data 204A, the first permeate stream data 204B, the second permeate stream data 204C, and the reference data 204D to the ML model 108. Specifically, the flowrate value of the seawater, the conductivity value of the seawater, the first flowrate value of the first permeate stream, the first conductivity value of the first permeate stream, the second flowrate value of the second permeate stream, the second conductivity value of the second permeate stream, the optimal flowrate value of the first permeate stream, the optimal conductivity value of the first permeate stream, the optimal flowrate value of the second permeate stream, the optimal conductivity value of the second permeate stream, and the optimal split ratio data may be provided as the input to the ML model 108. Further, the ML model 108 may generate a corrected flowrate value of the first permeate stream, a corrected conductivity value of the first permeate stream, a corrected flowrate value of the second permeate stream, and a corrected conductivity value of the second permeate stream, as the output of the ML model 108.

In an embodiment, the ML model 108 may be trained on a training dataset. The training dataset may include, but is not limited to, historical operational data associated with the desalination plant 106, historical first permeate stream data, and historical second permeate stream data. The processor 202 may be further configured to train the ML model 108 based on the historical operational data, the historical first permeate stream data, and the historical second permeate stream data. The said historical data may be associated with operational data of the desalination plant 106 over a time period. In an example, the historical data may include, but is not limited to, values associated with the operational data over the time period of 3 years.

The historical operational data may include, but is not limited to, a set of historical parameters associated with the seawater, historical data associated with the RO membrane unit, one or more historical quality parameters of the filtered liquid stream, a historical total dissolved solids (TDS) value of the filtered liquid stream, a historical recovery rate of the desalination plant 106, and historical split ratio data. Further, the historical first permeate stream data may include, but is not limited to, a historical flowrate value of the first permeate stream, and a historical conductivity value of the first permeate stream. The historical second permeate stream data may include, but is not limited to, a historical flowrate value of the second permeate stream, and a historical conductivity value of the second permeate stream.

Thereafter, the processor 202 may be configured to determine the split ratio value associated with the first permeate stream and the second permeate stream based on an output of the ML model 108.

At 312, first parameter may be modified. In an embodiment, the processor 202 may be configured to modify at least the first parameter of the set of parameters associated with the seawater based on the determined split ratio value. The first parameter of the set of parameters associated with the seawater corresponds to the flowrate value of the seawater. The flowrate value of the seawater impact efficiency and performance of the RO membrane unit 112, thereby modifying the flowrate based on the split ratio value may generate optimum amount of the first permeate stream that may not require the second step of filtration. In an example, the flowrate value of the seawater may be increased to optimize the first permeate stream. In another example, the flowrate value of the seawater may be decreased to optimize the amount of the first permeate stream. This may minimize the amount of the second permeate stream passed through the second step of filtration in the second pass of the desalination plant 106.

In an example, the processor 202 may be configured to modify the temperature value of the seawater based on the determined split ratio value. This may further modify viscosity and density of the seawater. In such a scenario, the processor 202 may be configured to determine the modified flowrate value of the seawater based on the temperature value of the seawater, and the conductivity value of the seawater. For example, if the temperature value of the seawater increases, a viscosity of the seawater will decrease, thereby increasing the flowrate value of the seawater. Further, if the conductivity value of the seawater increases indicating presence of dissolved impurities in the seawater, thereby decreasing the flowrate value of the seawater due to the dissolved impurities.

FIG. 4 is a diagram is a diagram that illustrates exemplary operations for optimizing operations of seawater reverse osmosis process using machine learning model, in accordance with an embodiment of the disclosure. FIG. 4 is explained in conjunction with elements from FIG. 1, FIG. 2, and FIG. 3. With reference to FIG. 4, there is shown the block diagram 400 of the system 102 that includes the ML model 108.

In an embodiment, the processor 202 may be configured to provide, as an input, the operational data 402, the first permeate stream data 204B, the second permeate stream data 204C, and the reference data 204D to the ML model 108. Specifically, the operational data 402 may include, but is not limited to, a flowrate value 402A of the seawater, a conductivity value 402B of the seawater, split ratio data 402C and membrane data 402D. Further, the ML model 108 may receive an optimal flowrate value 404A of the first permeate stream, the optimal conductivity value 406B of the first permeate stream, the optimal flowrate value 406A of the second permeate stream, the optimal conductivity value 404B of the second permeate stream, as the input.

Further, the ML model 108 may output the correction factor data 408. In an embodiment, the ML model 108 may be configured to determine the correction factor data 408 for the first pass. The correction factor data 408 may be used to optimize the operation and the design of the desalination plant 106. The optimized design and operation of the desalination plant 106 may minimize energy and/or chemicals consumed by the desalination plant 106 for converting the seawater to the freshwater for consumption. The ML model 108 may be configured to output the correction factor data 408 for improving or optimizing the performance of the membranes thereby enabling production of freshwater from the seawater with reduced energy.

The correction factor data 408 may include, but is not limited to, corrected values associated with conductivity and flowrate of the first permeate stream, and the second permeate stream. The corrected values, may include, but is not limited to, a corrected flowrate value of the first permeate stream, a corrected conductivity value of the first permeate stream, a corrected flowrate value of the second permeate stream, and a corrected conductivity value of the second permeate stream.

In an embodiment, the correction factor data 408 may correspond to a first deviation in one or more values associated with the first permeate stream data from corresponding one or more values associated with the reference first permeate stream data, and a second deviation in one or more values associated with the second permeate stream data from corresponding one or more values associated with the reference second permeate stream data. In an example, the first deviation may correspond to the corrected flowrate value of the first permeate stream. In other words, the first deviation may be a difference between the optimal flowrate value of the first permeate stream and first flowrate value of the first permeate stream. In another example, the first deviation may correspond to the corrected conductivity value of the first permeate stream. In other words, the first deviation may be a difference between the optimal conductivity value of the first permeate stream and first conductivity value of the first permeate stream.

In an example, the second deviation may correspond to the corrected flowrate value of the second permeate stream. In other words, the second deviation may be a difference between the optimal flowrate value of the second permeate stream and second flowrate value of the second permeate stream. In another example, the second deviation may correspond to the corrected conductivity value of the second permeate stream. In other words, the second deviation may be a difference between the optimal conductivity value of the second permeate stream and second conductivity value of the second permeate stream.

In an embodiment, the processor 202 may be configured to optimize the operation of the first pass by correcting the flowrate value of the seawater. The corrected values of conductivity and flowrate of the seawater may be used to obtain an optimal split ratio value between the first permeate stream flow and the second permeate stream to optimize operation and design of the desalination plant 106.

In an example, the first flowrate value of the first permeate stream may correspond to Q_{sim,front}, and the second flowrate value of the second permeate stream Q_{sim,rear}. Further, the first conductivity value of the first permeate stream may correspond to Cd_{sim,front}, and the second conductivity value of the second permeate stream Cd_{sim,rear}. Thereafter, the ML model 108 may generate the correction factor data 408 for the first pass. The ML model 108 may be trained to determine membrane performance data at different seawater operating ranges and permeate water properties based on the operational data 402 relating to the plurality of RO membranes 114 of the first step of filtration of the desalination plant 106, and the reference data 204D. Further, the ML model 108 may determine the corrected values based on the provided input. For example, the corrected flowrate value of the first permeate stream may correspond to Q_{real,front}, and the corrected flowrate value of the second permeate stream may correspond to Q_{real,rear}. Further, the corrected conductivity value of the first permeate stream may correspond to Cd_{real,front}, and the corrected conductivity value of the second permeate stream may correspond to Cd_{real,rear}.

In an embodiment, the processor 202 may be configured to retrieve one or more limiting criteria 410 associated with the desalination plant 106. The one or more limiting criteria 410 may include, but is not limited to, a first criterion associated with one or more quality parameters associated with the first permeate stream, and a second criterion associated with a quantity of the second permeate stream passed through the RO membrane unit to output at least a third permeate stream. In an example, the second criterion may relate to a load in the second step of filtration of the desalination plant 106 and the first criterion may relate to potable water quality desired from the first step of filtration.

In an example, the first criterion associated with one or more quality parameters associated with the first permeate stream may include, but are not limited to, physical parameters, chemical parameters, and biological parameters. The physical parameters may include, but are not limited to, colour, taste, odour, temperature, turbidity, solids, and electrical conductivity. The chemical parameters may include, include, but are not limited to, pH, acidity, alkalinity, chlorine, hardness, dissolved oxygen, and biological oxygen. The biological parameters, may include, but are not limited, to bacteria, algae, and viruses.

For example, the processor 202 may be configured to satisfy the first criterion by producing potable water quality desired in the first step of filtration of the desalination plant 106. When the first criterion is satisfied, the ML model 108 may be trained to determine the split ratio value based on the determined correction factor data 408. Thereafter, the processor 202 may be configured to evaluate the second criterion. On the contrary, when the first criterion is not satisfied, the ML model 108 may be trained to re-calculate the correction factor data 408.

In an example, the second criterion relating to the load in the second step of filtration of the second pass may be defined by:

$$maximize \vert Δ ( \frac{\sum {Q}_{second pass} \times {H}_{second pass feed pump}}{{N}_{initial number of pump}} ) \vert$$

For example, the above equation indicates minimizing the total amount of second liquid stream passing through the second step of filtration of the desalination plant 106. The product of the flowrate value of the second step of filtration of the desalination plant 106 (Q_{second pass}) and the load (H_{second pass feed pump}) in the second step of filtration of the desalination plant 106 represents a total amount of liquid passing through the second step of filtration of the desalination plant 106. Further, when such a product is divided by the number of pumps, provides an average load per pump, thereby helping in determining efficiency of each pump within the desalination plant 106.

For example, the processor 202 may be configured to satisfy the second criterion by minimizing the load in the second step of filtration of the desalination plant 106. When the second criterion is satisfied, the ML model 108 may be trained to determine the split ratio value based on the determined correction factor data 408. On the contrary, when the second criterion is not satisfied, the ML model 108 may be trained to re-calculate the correction factor data 408.

The processor 202 may be configured to evaluate one or more values associated with the correction factor data 408 based on the one or more limiting criteria 410 to determine the split ratio value 412. For example, the split ratio value 412 may be used in the first step of filtration to achieve the desired potable water quality, thereby reducing energy consumption, and enhancing performance of the desalination plant 106. In this manner, the operation and design of the desalination plant 106 may be optimized by optimizing the split ratio of the permeate stream to produce the filtered liquid stream based on the determined split ratio value.

For example, the processor 202 may be configured to check whether the limiting criteria 410 is satisfied for the optimization of the operation of the membranes of the desalination plant 106 by the determined corrected values. For example, if the one or more limiting criteria 410 are satisfied by the corrected values, the split ratio value 412 is determined for the first step of filtration based on the corrected values. On the contrary, if the corrected values fail to satisfy the one or more limiting criteria 410, the ML model 108 may be configured to determine another correction factor data to generate another corrected value for the permeate stream (such as the first permeate stream and the second permeate stream) of the first pass. This process may be repeated until the limiting criteria 410 may be satisfied based on the correction factor data 408 and corrected values associated with the corresponding iteration. In this manner, the optimal split ratio may be achieved for the permeate stream of the first pass to improve the operation of the desalination plant 106 performance.

In an embodiment, when the one or more limiting criteria 410 may not satisfy and an operating adjustment may be implemented within the ML model 108 to cause the ML model 108 to generate another correction factor data, thereby improving an accuracy of the ML model 108. In accordance with an example, the processor 202 may be configured to generate a recommendation for the desalination plant 106. The recommendation may be indicative of an adjustment of a first parameter associated with the seawater (such as the flowrate or pressure value of the seawater) in the desalination plant 106. In an example, the recommendation may be, but not limiting to, the split ratio value based on the optimal split ratio data to minimize energy consumption thereof.

The optimal split ratio value achieved for the first permeate stream may be employed to mix the first permeate stream, and the third permeate stream to produce the output (the filtered liquid stream) of the desalination plant 106 based on the ML model 108. Further, the optimal split ratio may be indicated by a percentage (%) of the permeate stream of the first step of filtration that yields minimal amount of water to be treated by second step of filtration.

Embodiments of the present example are explained in conjunction with optimizing the first pass of the desalination plant 106. However, this should not be construed as a limitation. In other examples of the present disclosure, the ML model 108 may be used to optimize the second pass of the desalination plant 106.

FIG. 5 is a flowchart that illustrates an exemplary method for optimizing operations of seawater reverse osmosis process, in accordance with an embodiment of the disclosure. FIG. 5 is explained in conjunction with elements from FIGS. 1, 2, 3, and 4. With reference to FIG. 5 there is shown a flowchart 500. The operations of the exemplary method may be executed by any computing system, for example, by the system 102 of FIG. 1 or the processor 202 of FIG. 2. The operations of the flowchart 500 may start at 502.

At 502, the operational data may be received. In an embodiment, the processor 202 may be configured to receive the operational data 204A associated with the desalination plant 106. The operational data 204A includes a set of parameters associated with seawater. Further, the seawater is passed through a reverse osmosis (RO) membrane unit 112 to output at least a first permeate stream and a second permeate stream.

At 504, first permeate stream data may be received. In an embodiment, the processor 202 may be configured to receive the first permeate stream data 204B including a first flowrate value of the first permeate stream, and a first conductivity value of the first permeate stream.

At 506, second permeate stream data may be received. In an embodiment, the processor 202 may be configured to receive the second permeate stream data 204C including a first flowrate value of the second permeate stream, and a first conductivity value of the second permeate stream.

At 508, reference data may be retrieved. In an embodiment, the processor 202 may be configured to retrieve the reference data 204D associated with the desalination plant 106. The reference data 204D includes reference first permeate stream data, and reference second permeate stream data.

At 510, an input to a machine learning (ML) model may be provided. In an embodiment, the processor 202 may be configured to provide, as the input, the operational data 204A, the first permeate stream data 204B, the second permeate stream data 204C, and the reference data 204D to the ML model 108.

At 512, a split ratio value may be determined. In an embodiment, the processor 202 may be configured to determine the split ratio value associated with the first permeate stream and the second permeate stream based on an output of the ML model 108.

At 514, a first parameter may be modified. In an embodiment, the processor 202 may be configured to modify at least the first parameter of the set of parameters associated with the seawater based on the determined split ratio value.

Alternatively, the system 102 may include means for performing each of the operations described above. In this regard, according to an example embodiment, examples of means for performing operations may comprise, for example, the processor and/or a device or circuit for executing instructions or executing an algorithm for processing information as described above.

Various embodiments of the disclosure may provide a non-transitory computer readable medium having stored thereon computer executable instructions, which when executed by one or more processors (such as the processor 202), cause the one or more processors to carry out operations to operate a system (e.g., the system 102) for optimizing the seawater reverse osmosis process. The instructions may cause the machine and/or computer to perform operations including receiving operational data associated with a desalination plant. The operational data includes a set of parameters associated with seawater. Further, the seawater is passed through a reverse osmosis (RO) membrane unit to output at least a first permeate stream and a second permeate stream. The operations may include receiving first permeate stream data including a flowrate of the first permeate stream, and a conductivity value of the first permeate stream. The operations may include receiving second permeate stream data including a flowrate of the second permeate stream, and a conductivity value of the second permeate stream. The operations may include retrieving reference data associated with the desalination plant. The reference data includes reference first permeate stream data, and reference second permeate stream data. Further, the operations may include providing, as an input, the operational data, the first permeate stream data, the second permeate stream data, and the reference data to a Machine Learning (ML) model. The operations may include determining a split ratio value associated with the first permeate stream and the second permeate stream based on an output of the ML model and modify at least a first parameter of the set of parameters associated with the seawater based on the determined split ratio value.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. A system, comprising:
a memory configured to store computer-executable instructions; and
one or more processors coupled to the memory, wherein the one or more processors are configured to:
receive operational data associated with a desalination plant, wherein the operational data comprises a set of parameters associated with seawater, and wherein the seawater is passed through a reverse osmosis (RO) membrane unit to output at least: a first permeate stream and a second permeate stream;
receive first permeate stream data comprising a first flowrate value of the first permeate stream, and a first conductivity value of the first permeate stream;
receive second permeate stream data comprising a second flowrate value of the second permeate stream, and a second conductivity value of the second permeate stream;
retrieve reference data associated with the desalination plant, wherein the reference data comprises reference first permeate stream data, and reference second permeate stream data;
provide, as an input, the operational data, the first permeate stream data, the second permeate stream data, and the reference data to a Machine Learning (ML) model;
determine a split ratio value associated with the first permeate stream and the second permeate stream based on an output of the ML model; and
modify at least a first parameter of the set of parameters associated with the seawater based on the determined split ratio value.

2. The system of claim 1, wherein the output of the ML model is correction factor data, and wherein the correction factor data corresponds to a first deviation in one or more values associated with the first permeate stream data from corresponding one or more values associated with the reference first permeate stream data, and a second deviation in one or more values associated with the second permeate stream data from corresponding one or more values associated with the reference second permeate stream data.

3. The system of claim 2, wherein the one or more processors are further configured to:
retrieve one or more limiting criteria associated with the desalination plant; and
evaluate one or more values associated with the correction factor data based on the one or more limiting criteria to determine the split ratio value.

4. The system of claim 3, wherein the one or more limiting criteria comprises at least:
a first criterion associated with one or more quality parameters associated with the first permeate stream; and
a second criterion associated with a quantity of the second permeate stream passed through the RO membrane unit to output at least: a third permeate stream.

5. The system of claim 4, wherein the desalination plant produces a filtered liquid stream from the seawater, and wherein the filtered liquid stream comprises the first permeate stream and the third permeate stream.

6. The system of claim 1, wherein the ML model is trained on a training dataset comprising historical operational data associated with the desalination plant, historical first permeate stream data, and historical second permeate stream data, and wherein the one or more processors are further configured to:
train the ML model based on the historical operational data, the historical first permeate stream data, and the historical second permeate stream data.

7. The system of claim 1, wherein the first parameter of the set of parameters associated with the seawater corresponds to a flowrate value of the seawater.

8. The system of claim 1, wherein the set of parameters associated with the seawater comprises at least one of: a flowrate value of the seawater, a temperature value of the seawater, a conductivity value of the seawater, chemical composition data associated with the seawater, a density of the seawater, a Potential of Hydrogen (pH) value of the seawater, and a total dissolved solids (TDS) value of the seawater.

9. The system of claim 1, wherein the operational data associated with the desalination plant further comprises at least one of: data associated with the RO membrane unit, one or more quality parameters of a filtered liquid stream, a total dissolved solids (TDS) value of the filtered liquid stream, a recovery rate of the desalination plant, and split ratio data.

10. The system of claim 1, wherein the reference first permeate stream data comprises an optimal flowrate value of the first permeate stream, and an optimal conductivity value of the first permeate stream, and wherein the reference second permeate stream data comprises an optimal flowrate value of the second permeate stream, and an optimal conductivity value of the second permeate stream.

11. The system of claim 1, wherein the reference data further comprises: an optimal flowrate value of the seawater, an optimal conductivity value of the seawater, one or more optimal quality parameters associated with a filtered liquid stream, and optimal split ratio data.

12. A method, comprising:
receiving operational data associated with a desalination plant, wherein the operational data comprises a set of parameters associated with seawater, and wherein the seawater is passed through a reverse osmosis (RO) membrane unit to output at least: a first permeate stream and a second permeate stream;
receiving first permeate stream data comprising a first flowrate value of the first permeate stream, and a first conductivity value of the first permeate stream;
receiving second permeate stream data comprising a second flowrate value of the second permeate stream, and a second conductivity value of the second permeate stream;
retrieving reference data associated with the desalination plant, wherein the reference data comprises reference first permeate stream data, and reference second permeate stream data;
providing, as an input, the operational data, the first permeate stream data, the second permeate stream data, and the reference data to a Machine Learning (ML) model;
determining a split ratio value associated with the first permeate stream and the second permeate stream based on an output of the ML model; and
modifying at least a first parameter of the set of parameters associated with the seawater based on the determined split ratio value.

13. The method of claim 12, wherein the output of the ML model is correction factor data, and wherein the correction factor data corresponds to a first deviation in one or more values associated with the first permeate stream data from corresponding one or more values associated with the reference first permeate stream data, and a second deviation in one or more values associated with the second permeate stream data from the corresponding one or more values associated with the reference second permeate stream data.

14. The method of claim 13, further comprising:
retrieving one or more limiting criteria associated with the desalination plant; and
evaluating one or more values associated with the correction factor data based on the one or more limiting criteria to determine the split ratio value.

15. The method of claim 14, wherein the one or more limiting criteria comprises at least:
a first criterion associated with one or more quality parameters associated with the first permeate stream; and
a second criterion associated with a quantity of the second permeate stream passed through the RO membrane unit to output at least: a third permeate stream.

16. The method of claim 12, wherein the ML model is trained on a training dataset comprising historical operational data associated with the desalination plant, historical first permeate stream data, and historical second permeate stream data, and wherein the method further comprising:
training the ML model based on the historical operational data, the historical first permeate stream data, and the historical second permeate stream data.

17. The method of claim 12, wherein the first parameter of the set of parameters associated with the seawater corresponds to a flowrate value of the seawater.

18. The method of claim 12, wherein the set of parameters associated with the seawater comprises at least one of: a flowrate value of the seawater, a temperature value of the seawater, a conductivity value of the seawater, chemical composition data associated with the seawater, a density of the seawater, a Potential of Hydrogen (pH) value of the seawater, and a total dissolved solids (TDS) value of the seawater.

19. The method of claim 12, wherein the operational data associated with the desalination plant further comprises at least one of: data associated with the RO membrane unit, one or more quality parameters of a filtered liquid stream, a total dissolved solids (TDS) value of the filtered liquid stream, a recovery rate of the desalination plant, and split ratio data.

20. A non-transitory computer-readable medium having stored thereon, computer-executable instructions that when executed by a processor of a system, causes the processor to execute operations, the operations comprising:
receiving operational data associated with a desalination plant, wherein the operational data comprises a set of parameters associated with seawater, and wherein the seawater is passed through a reverse osmosis (RO) membrane unit to output at least: a first permeate stream and a second permeate stream;
receiving first permeate stream data comprising a first flowrate value of the first permeate stream, and a first conductivity value of the first permeate stream;
receiving second permeate stream data comprising a second flowrate value of the second permeate stream, and a second conductivity value of the second permeate stream;
retrieving reference data associated with the desalination plant, wherein the reference data comprises reference first permeate stream data, and reference second permeate stream data;
providing, as an input, the operational data, the first permeate stream data, the second permeate stream data, and the reference data to a Machine Learning (ML) model;
determining a split ratio value associated with the first permeate stream and the second permeate stream based on an output of the ML model; and
modifying at least a first parameter of the set of parameters associated with the seawater based on the determined split ratio value.
